(19) United States
(12) Patent Application Publication
(10) Pub. No.: US 2021/0086360 A1
(43) Pub. Date: Mar. 25, 2021

(54) METHOD, SYSTEM, AND NON-TRANSITORY COMPUTER-READABLE RECORDING MEDIUM FOR PROVIDING ROBOT SIMULATOR

(71) Applicant: Macroact Inc., Seongnam-si (KR)

(72) Inventor: Eui Hyeoc KANG, Gyeonggi-do (KR)

(73) Assignee: Macroact Inc., Seongnam-si (KR)

(21) Appl. No.: 17/113,709

(22) Filed: Dec. 7, 2020

Related U.S. Application Data
(63) Continuation of application No. PCT/KR2019/007185, filed on Jun. 14, 2019.

(30) Foreign Application Priority Data
Jun. 14, 2018 (KR) 10-2018-0068234

(51) Int. Cl. B25J 9/16; G06N 20/00; G05B 19/4155

(52) U.S. Cl. CPC B25J 9/1671; B25J 9/1664; G05B 2219/40499; G05B 19/4155; G06N 20/00

(57) ABSTRACT

There is provided a method for training a robot using a robot simulator. The method includes the steps of: acquiring specification information on at least one component included in the robot; when at least one training task is given, training an operation of each of the at least one component required to complete the at least one training task, within an operable range according to the specification information; and when a performance task is given, determining an operation to be performed by each of the at least one component to complete the performance task, on the basis of a result of the training.

### CROSS-REFERENCE TO RELATED APPLICATION(S)

This application is a continuation application of Patent Cooperation Treaty (PCT) International Application No. PCT/KR2019/007185 filed on Jun. 14, 2019, which claims priority to Korean Patent Application No. 10-2018-0068234 filed on Jun. 14, 2018. The entire contents of PCT International Application No. PCT/KR2019/007185 and Korean Patent Application No. 10-2018-0068234 are hereby incorporated by reference.

### FIELD OF THE INVENTION

The present invention relates to a method, system, and non-transitory computer-readable recording medium for providing a robot simulator.

### BACKGROUND

With the development of robot technology, process automations using robots in various work environments are currently ongoing, thereby improving the work efficiency and productivity of processes.

Conventionally, in order to utilize a robot in an industrial site, a method is used in which an expert personally checks operations of the robot in the site and sets desired operations for the robot. Further, in order to control motion of the robot according to a given purpose, the expert should substitute appropriate formulas and values and measure results thereof.

However, this method can only be performed by an experienced expert, and it takes a lot of time since the operations are checked one by one, which makes it difficult to quickly respond to task changes. In addition, through the iterative processes of substituting appropriate formulas and values and measuring the results to control the motion of the robot, major component wearout and power consumption may occur and parts are often discarded due to incorrect input values.

In order to solve this problem, a method of creating a task of a robot in a simulator is employed. However, this method has a problem that an expert should periodically enter input values in the simulator. In addition, there is a problem that the robot simulator cannot be operated due to incorrect information or incorrect input values for components constituting the robot.

### SUMMARY OF THE INVENTION

One object of the present invention is to solve all the above-described problems in the prior art.

Another object of the invention is to provide a robot simulator system in which an expert does not need to periodically enter input values for operations of a robot in a virtual simulator environment.

Yet another object of the invention is to provide a system capable of training operations of a robot on a component basis.

Still another object of the invention is to assist a robot to complete a given task by training, even if some of components constituting the robot do not operate normally, operations of the other normally operating components according to the given task, and determining operations of the other components on the basis of a result of the training.

The representative configurations of the invention to achieve the above objects are described below.

According to one aspect of the invention, there is provided a method for training a robot using a robot simulator, the method comprising the steps of: acquiring specification information on at least one component included in the robot; when at least one training task is given, training an operation of each of the at least one component required to complete the at least one training task, within an operable range according to the specification information; and when a performance task is given, determining an operation to be performed by each of the at least one component to complete the performance task, on the basis of a result of the training.

According to another aspect of the invention, there is provided a system for training a robot using a robot simulator, the system comprising: a specification information acquisition unit configured to acquire specification information on at least one component included in the robot; an operation training unit configured to, when at least one training task is given, train an operation of each of the at least one component required to complete the at least one training task, within an operable range according to the specification information; and an operation determination unit configured to, when a performance task is given, determine an operation to be performed by each of the at least one component to complete the performance task, on the basis of a result of the training.

In addition, there are further provided other methods and systems to implement the invention, as well as non-transitory computer-readable recording media having stored thereon computer programs for executing the methods.

According to the invention, it is possible to provide a robot simulator system in which an expert does not need to periodically enter input values for operations of a robot in a virtual simulator environment.

According to the invention, it is possible to provide a system capable of training operations of a robot on a component basis.

According to the invention, it is possible to assist a robot to complete a given task by training, even if some of components constituting the robot do not operate normally, operations of the other normally operating components according to the given task, and determining operations of the other components on the basis of a result of the training.

### BRIEF DESCRIPTION OF THE DRAWINGS

FIG. 1 specifically shows the internal configuration of a robot simulator system according to one embodiment of the invention.

FIG. 2 illustratively shows that operations of components included in a robot are trained according to one embodiment of the invention.

FIG. 3 illustratively shows that operations of components included in a robot are trained according to one embodiment of the invention.

FIG. 4 illustratively shows that a robot tries to complete a performance task as a robot simulator system is running according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the embodiments may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

### Configuration of a Robot Simulator System

Hereinafter, the internal configuration of a robot simulator system crucial for implementing the invention and the functions of the respective components thereof will be discussed.

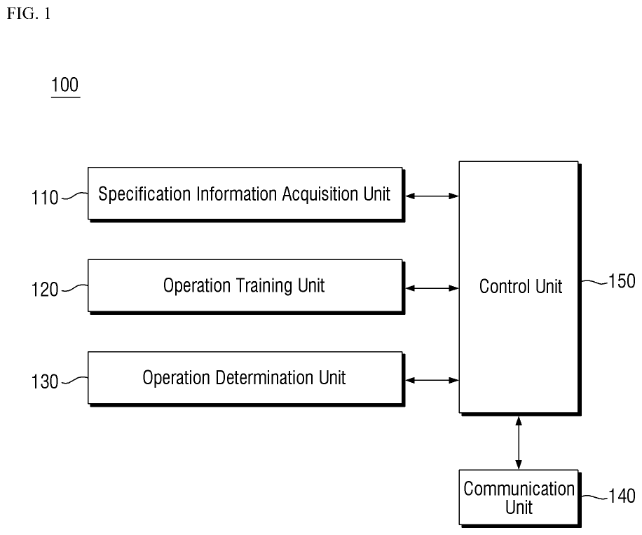

FIG. 1 specifically shows the internal configuration of a robot simulator system 100 according to one embodiment of the invention.

As shown in FIG. 1, the robot simulator system 100 according to one embodiment of the invention may comprise a specification information acquisition unit 110, an operation training unit 120, an operation determination unit 130, a communication unit 140, and a control unit 150. According to one embodiment of the invention, at least some of the specification information acquisition unit 110, the operation training unit 120, the operation determination unit 130, the communication unit 140, and the control unit 150 may be program modules to communicate with an external system. The program modules may be included in the robot simulator system 100 in the form of operating systems, application program modules, and other program modules, while they may be physically stored in a variety of commonly known storage devices. Further, the program modules may also be stored in a remote storage device that may communicate with the robot simulator system 100. Meanwhile, such program modules may include, but not limited to, routines, subroutines, programs, objects, components, data structures, and the like for performing specific tasks or executing specific abstract data types as will be described below in accordance with the invention.

Meanwhile, although the robot simulator system 100 has been described as above, the above description is illustrative and it will be apparent to those skilled in the art that at least a part of the components or functions of the robot simulator system 100 may be implemented or included in an external system (not shown), as necessary.

First, the specification information acquisition unit 110 according to one embodiment of the invention may function to acquire specification information on at least one component included in a robot. Here, the specification information may be numerical indexes indicating performance and characteristics (e.g., dimensions, weights, and the like) of components constituting an actual robot. Further, the at least one component may include a first component and a second component, and these components may be connected in an organic relationship with each other. For example, the first component may be composed of a power device for driving the robot and the second component may be composed of a sensing device for sensing a certain object, while the first and second components may implement a mechanism for performing a predetermined task.

Meanwhile, the components that may be included in the robot according to the invention are not necessarily limited to the foregoing, and it may be assumed that various components may be included in the robot without limitation as long as the objects of the invention may be achieved.

Further, it is noted that the use or purpose of each of the components included in the robot according to the invention may be dynamically changed depending on tasks given to the robot.

In addition, according to one embodiment of the invention, a user may enter specification information of a frequently used component among the at least one component included in the robot in advance, so that the user may have the convenience of not having to enter the specification information every time a simulation is performed.

Next, when at least one training task is given, the operation training unit 120 according to one embodiment of the invention may train an operation of each of the at least one component required to complete the at least one training task, within an operable range according to the specification information.

For example, when a task of avoiding a space, wall, or obstacle in a simulator is given, the operation training unit 120 may train an operation of the first component and an operation of the second component, which are required for the robot to perform the training task, within operable ranges according to the specification information of the first and second components, respectively.

Further, according to one embodiment of the invention, the training of the operation of the first component and the training of the operation of the second component may be performed with reference to each other. Specifically, according to one embodiment of the invention, when a training task of reaching a target object is given to a robot composed of a first component and a second component, the operation training unit 120 may identify the respective characteristics (i.e., operable ranges) of the first and second components on the basis of the specification information acquired from the specification information acquisition unit 110, and may try the respective operations of the first and second components one by one on the basis of the identification. For example, the first and second components may perform various types of operations such as rotation, upward/downward movement, and linear motion. Next, the operation training unit 120 may train the respective operations of the first and second components that minimize time or energy required to reach the target object, and may store data on the trained operations of the first and second components in a database.

Next, when a performance task is given, the operation determination unit 130 according to one embodiment of the invention may determine an operation to be performed by each of the at least one component included in the robot to complete the performance task, on the basis of a result of the previously performed training.

Here, according to one embodiment of the invention, a known machine learning or deep learning algorithm such as a convolutional neural network (CNN) algorithm may be used as a technique for training and determining operations of components included in a robot. However, the technique that may be used in the invention is not necessarily limited to the foregoing, and may be changed without limitation as long as the objects of the invention may be achieved.

Next, the communication unit 140 according to one embodiment of the invention may function to enable data transmission/reception from/to the specification information acquisition unit 110, the operation training unit 120, and the operation determination unit 130.

Lastly, the control unit 150 according to one embodiment of the invention may function to control data flow among the specification information acquisition unit 110, the operation training unit 120, the operation determination unit 130, and the communication unit 140. That is, the control unit 150 according to the invention may control data flow into/out of the robot simulator system 100 or data flow among the respective components of the robot simulator system 100, such that the specification information acquisition unit 110, the operation training unit 120, the operation determination unit 130, and the communication unit 140 may carry out their particular functions, respectively.

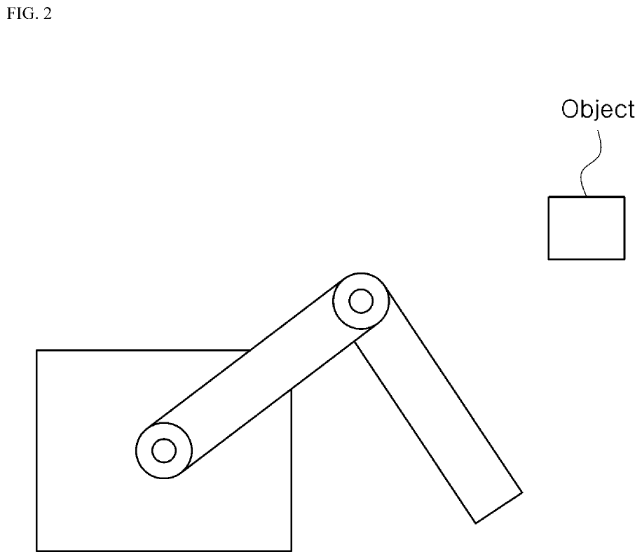

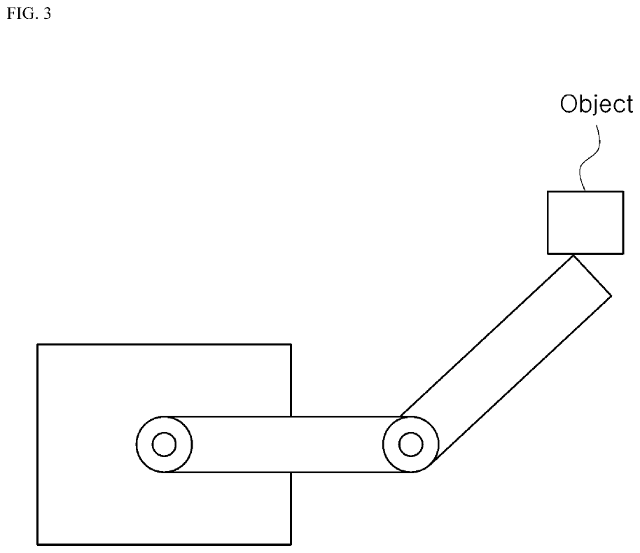

FIGS. 2 and 3 illustratively show that operations of components included in a robot are trained according to one embodiment of the invention.

First, referring to FIG. 2, when the robot is given a training task of reaching a target object located around the robot, the robot simulator system 100 according to one embodiment of the invention may train an operation of each of the components included in the robot that is required for the robot to reach the target object, on the basis of information on a position of the target object and specification information of the components.

Next, referring to FIG. 3, the robot simulator system 100 according to one embodiment of the invention may generate and operate training data indicating that the respective operations of the components to minimize time or energy required for the robot to reach the target object are the optimal operations for the training task.

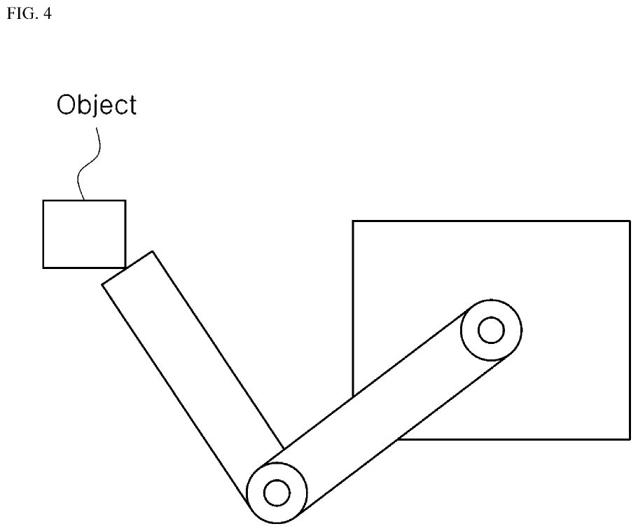

FIG. 4 illustratively shows that components included in a robot operate to complete a performance task according to one embodiment of the invention.

Referring to FIG. 4, when the robot is given a performance task of reaching a target object located in a specific position indicated by a user, the robot simulator system 100 according to one embodiment of the invention may determine an operation to be performed by each of the components included in the robot to complete the performance task, on the basis of a result of the training performed in connection with FIGS. 2 and 3.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for training a robot using a robot simulator, the method comprising the steps of:
acquiring specification information on at least one component included in the robot;
when at least one training task is given, training an operation of each of the at least one component required to complete the at least one training task, within an operable range according to the specification information; and
when a performance task is given, determining an operation to be performed by each of the at least one component to complete the performance task, on the basis of a result of the training.

2. The method of claim 1, wherein the at least one component includes a first component and a second component,
wherein in the training step, the operation of the first component and the operation of the second component are respectively trained, and
wherein in the determining step, the operation of the first component and the operation of the second component are respectively determined.

3. The method of claim 2, wherein in the training step, the training of the operation of the first component and the training of the operation of the second component are performed with reference to each other.

4. A non-transitory computer-readable recording medium having stored thereon a computer program for executing the method of claim 1.

5. A system for training a robot using a robot simulator, the system comprising:
a specification information acquisition unit configured to acquire specification information on at least one component included in the robot;
an operation training unit configured to, when at least one training task is given, train an operation of each of the at least one component required to complete the at least one training task, within an operable range according to the specification information; and
an operation determination unit configured to, when a performance task is given, determine an operation to be performed by each of the at least one component to complete the performance task, on the basis of a result of the training.
